(19) United States
(12) Patent Application Publication
(10) Pub. No.: US 2010/0038171 A1
(43) Pub. Date: Feb. 18, 2010

(54) Clamp Assembly

(75) Inventor: Ian Larard, Queensland (AU)

Correspondence Address: SHOEMAKER AND MATTARE, LTD, 10 POST OFFICE ROAD - SUITE 100, SILVER SPRING, MD, 20910, US

(73) Assignee: I & S LARARD PTY LTD., Yelarbon, Queensland (AU)

(21) Appl. No.: 12/441,062

(22) PCT Filed: Sep. 14, 2007
(86) PCT No.: PCT/AU07/01360

§ 371 Date: Mar. 12, 2009

(30) Foreign Application Priority Data
Sep. 14, 2006 (AU) 2006905078

(51) Int. Cl. E06C 7/48; E06C 1/04; E06C 1/34

(52) U.S. Cl. 182/107

(57) ABSTRACT

A clamping assembly for clamping a ladder to a support such a roof gutter wall or scaffolding tubing includes a pair of opposing arms hinged together and spring biased to assist in locating the clamping arms about the support. The inner side of the clamping arm has a recess to accommodate the support or part thereof. The clamping assembly has a fastener to fix the clamping arms in position and a securing means such as a fixed chain to position about the stile or rung of a ladder. An advantage is that a section of the clamping arms clamps to a section of the support thereby providing a clamping force over a sectional area rather than at a single point.

### FIELD OF INVENTION

The present invention relates to a clamp for clamping a ladder to a support. The present invention has particular but not exclusive application for clamping a ladder to a roof gutter wall. In the body of the specification, the use of the clamp assembly to clamp a ladder to a roof gutter is made by way of example only and the invention is not limited to this example.

### BACKGROUND OF THE INVENTION

Ladders are generally not secured to eaves or gutters and as a consequence there are a number of accidents each year relating to falls off and from unsecured ladders. Some of these accidents may be prevented if the ladders were secured. In addition unsecured ladders scratch and damage gutters when they are dislodged.

A device for securing a ladder to the gutter was described in published PCT application WO 2005/124089. The device consists of a clamp that clamps to the gutter wall and a locking bar that secures to the adjacent stile of the ladder.

However, the device clamps at a single point which may cause the device to slip or the gutter wall to bend when there is a large downward and or outward force. Furthermore the mechanism of the device is complicated relying on multiple interacting parts to effect clamping. With the complicated mechanism, the device has a potential risk of failure if one or more parts break down.

### OBJECT OF THE INVENTION

It is an object of the present invention to provide a clamping assembly that overcomes at least in part one or more of the abovementioned disadvantages.

### SUMMARY OF THE INVENTION

In one aspect the present invention broadly resides in a clamp assembly for securing a ladder to a support including

two clamping arms which are connected or connectable to each other and positionable about the support so that the clamping arms abut a substantial section of the support, at least one of the clamping arms has a recess formed in a clamping side to accommodate the support or part thereof;

a fastening member to engage and fix one clamping arm to the other clamping arm; and

a securing member to attach to the ladder, the securing member is fixed to one of the clamping arms wherein in use the two clamping arms oppose each other to clamp the support between the clamping arms with the clamping sides of each of the clamping arms abutting a substantial section of the support and the securing member is positionable to attach to the section of the ladder thereby securing the ladder to the support.

In another aspect the present invention broadly resides in a clamp assembly for securing a ladder to a roof gutter wall including

two clamping arms which are connected or connectable to each other and positionable about the roof gutter wall so that the clamping arms abut a substantial section of the roof gutter wall, at least one of the clamping arms has a recess formed in a clamping side to accommodate the roof gutter wall or part thereof;

a fastening member to engage and fix one clamping arm to the other clamping arm; and

a securing member to attach to the ladder, the securing member is fixed to one of the clamping arms wherein in use the two clamping arms oppose each other to clamp the roof gutter wall between the clamping arms with the clamping sides of each of the clamping arms abutting a substantial section of the roof gutter wall and the securing member is positionable to attach to the section of the ladder thereby securing the ladder to the roof gutter wall.

The clamping arms are preferably separate arms. Alternatively the arms may be portions of a larger device.

Preferably, each clamping arm is elongate.

In a preferred embodiment each clamping arm is in the shape of a rectangular block.

The clamping side of each of the clamping arms is preferably a substantially flat surface or shaped to abut with the support.

In one embodiment the recess is shaped to accommodate the fold or beading of a gutter wall. In another embodiment the recess has a substantially concave shape to accommodate a scaffolding tube or part thereof.

The recess preferably extends across the width of the clamping arm.

In one embodiment both of the clamping arms have a recess. Where both clamping arms have a recess, the recesses are preferably aligned and oppose each other in respective clamping arms. Alternately the recesses may preferably not be aligned.

The fastening member preferably includes a threaded fastener such as a bolt and a nut. The nut is preferably an insert nut positioned within the arm.

The securing member is preferably a length of chain. The length of chain can preferably form a loop to encompass a stile or rung of a ladder.

The length of chain preferably has a clip at a free end of the chain for clipping onto itself.

Preferably, the securing member includes a U-bolt that is fixed to the clamping arm.

Preferably one clamping arm is pivotally attached to the other clamping arm. More preferably, there is a hinge between the clamping arms. The clamping arms are preferably hinged about an end of each clamping arm.

The clamping arms are preferably spring biased relative to each other. The clamping arms are preferably spring biased to come together for ease in positioning the clamping arms about the support.

In one embodiment, the hinge is spring biased.

In an alternate embodiment there is a separate spring extending from one clamping arm to the other clamping arm. More preferably there are two separate compression springs extending between the clamping arms.

Each of the separate springs preferably has a spring end that is attached to a pin. The pin is preferably held within the clamping arm.

To secure a ladder, a single clamping assembly may be used, but preferably two clamping assemblies are used where one is on each side of the ladder.

### BRIEF DESCRIPTION OF THE DRAWINGS

In order that the present invention can be more readily understood reference will now be made to the accompanying drawings which illustrate preferred embodiments of the invention and wherein:

FIG. 1 is a diagrammatic exploded view of a clamp assembly according to first embodiment of the invention;

FIG. 2 is a diagrammatic view of the clamp assembly of FIG. 1 showing the clamping arms in an open position;

FIG. 3 is a diagrammatic view of the clamp assembly of FIG. 2 showing the clamping arms fixed in a closed position;

FIG. 4 is a diagrammatic view of a clamp assembly according to a second embodiment of the invention;

FIGS. 5A and 5B are diagrammatic views of a clamp assembly according to a third embodiment of the invention; and

FIG. 6 is a diagrammatic view of a clamp assembly according to a fourth embodiment of the invention.

### DETAILED DESCRIPTION OF THE PREFERRED EMBODIMENT

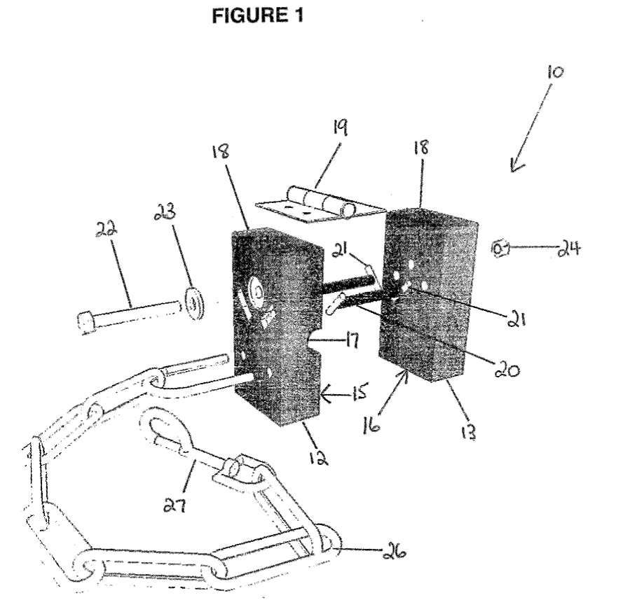

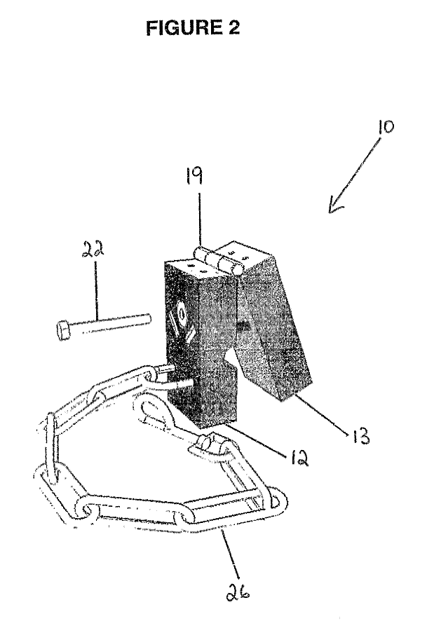

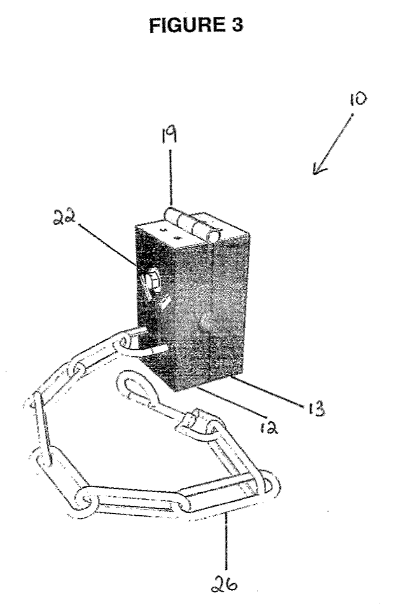

With reference to FIGS. 1 to 3, there is shown a clamp assembly 10 that can be used for securing a ladder to a roof gutter wall. The clamp assembly 10 has two clamping arms 12, 13 and a securing chain 26 that is fixed to one of the clamping arms 12. The roof gutter wall is clamped between the clamping arms 12, 13 and the securing chain 26 is looped around a stile or rung of the ladder to secure the ladder to the roof gutter.

Each clamping arm 12, 13 is in the shape of a rectangular block. Each clamping arm 12, 13 has a clamping side 15,16 respectively that abuts the roof gutter wall. The clamping sides 15,16 abut a section of the roof gutter wall. In other embodiments the clamping sides have complementary shaped sides to the support sides such as sides of roof gutter walls and scaffolding tubing. The clamping side 15 has a recess 17 that extends across the width of the clamping arm 12. The clamping arm 12 is the outer clamping arm when positioned about the roof gutter wall. The recess 17 accommodates the outwardly disposed bead or fold of the roof gutter wall. The recess 17 is concave in shape.

The clamping arms 12,13 are hinged together on their top surface 18 so that the clamping arms 12,13 can open outwardly about the hinge 19. The clamping assembly 10 has two compression springs 20 attached to and extending between the clamping arms 12,13. The compression springs 20 are retained in each arm by transversely disposed pins 21. The compression springs 20 serve to bring the clamping arms 12,13 together and facilitate positioning of the clamping arms about the roof gutter wall.

The clamping arms 12,13 are fastened together via a threaded bolt 22, washer 23 and nut 24. The clamping arms 12,13 are fastened after they are positioned about the roof gutter wall so to clamp the clamping arms 12,13 onto the roof gutter wall.

The clamping arm 12 has a chain 26 for fixing the clamping arms 12,13 to the ladder. The chain 26 is fixed to the clamping arm 12 and can encompass the stile or rung of the ladder. The end of the chain 26 has a clip 27 for attaching onto itself.

In use the clamping arms 12,13 are positioned about the roof gutter wall and locating the outward gutter fold or bead within recess 17. After positioning, the clamping arms 12,13 are fastened with the threaded bolt 22, washer 23 and nut 24 to fix the position of the clamping arms 12,13 relative to each other. The chain 26 is then wrapped around the ladder rung or stile and clipped onto a chain link with clip 27. Preferably a clamping assembly is positioned on each side of the gutter to provide additional clamping security and safety.

The clamping assembly 10 is easy to use and able to quickly secure the ladder to the roof gutter wall (or scaffolding or other support). The clamping assembly 10 can be carried around on a workman's belt or remain attached to the ladder. The advantage of the clamping assembly 10 is that a section of the clamping arms 12,13 clamps to a section of the roof gutter wall thereby providing a clamping force over a sectional area rather than at a single point.

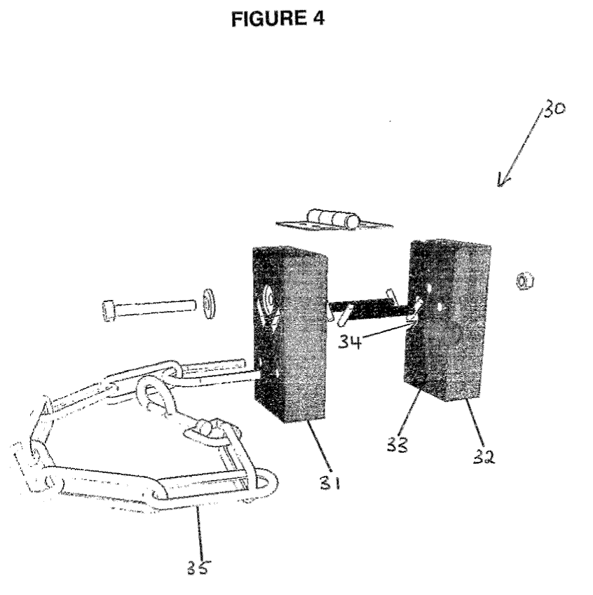

With reference to FIG. 4, there is shown a second embodiment of the clamping assembly 30 having clamping arms 31,32. Clamping arm 32 is the inner clamping arm with a clamping surface 33. The clamping surface 33 has a concave recess 34 to accommodate inwardly folding or beading of the roof gutter wall. Clamping arm 31 is the outer clamping arm with chain 35 for fastening about the ladder.

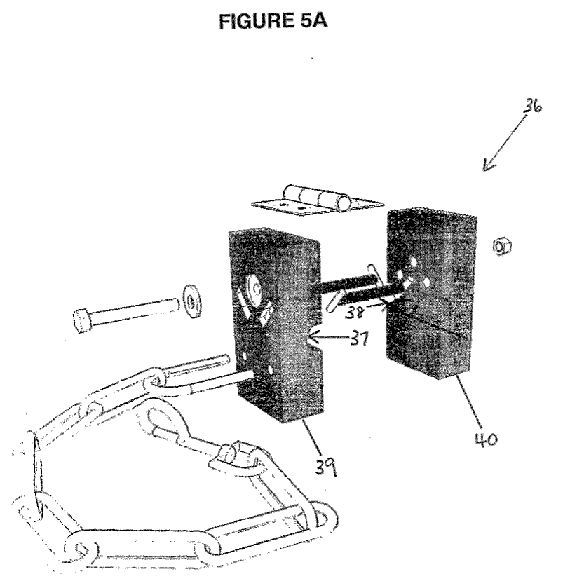

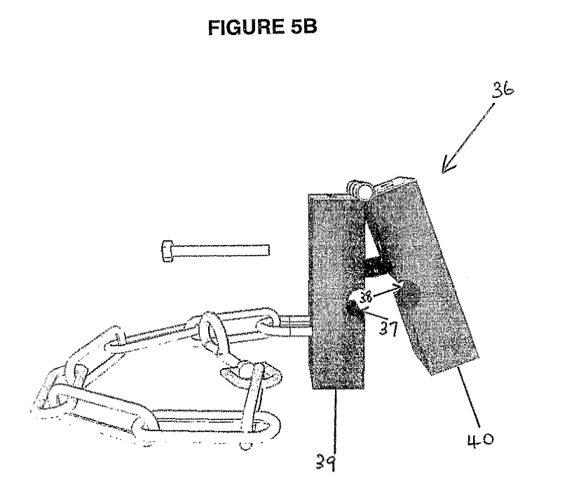

With reference to FIG. 5, there is shown a third embodiment of the clamping assembly 36 having two opposing concave recesses 37,38 in opposing arms 39,40 for clamping to a roof gutter wall irrespective of whether the fold or beading is outwardly or inwardly disposed. The opposing recesses 37, 38 are substantially aligned. In an alternative embodiment the opposing recesses 37,38 are staggered.

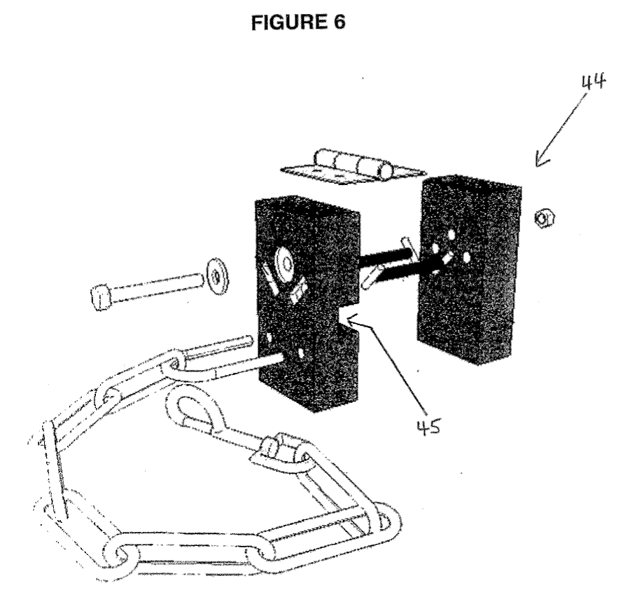

With reference to FIG. 6, there is shown a fourth embodiment of the clamping assembly 44 that is similar to the clamping assembly shown in FIG. 4 except that the recess 45 is substantially rectangular in shape. In an alternate embodiment, the recess can be on the other clamping arm. In further embodiment, there are two recesses preferably opposing each other on alternate clamping arms.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1-16. (canceled)

17. A clamp assembly for securing a ladder to a support including
two clamping arms which are connected or connectable to each other and positionable about the support so that the clamping arms abut a substantial section of the support, at least one of the clamping arms has a recess formed in a clamping side to accommodate the support or part thereof;
a fastening member to engage and fix one clamping arm to the other clamping arm; and
a securing member to attach to the ladder, the securing member is fixed to one of the clamping arms wherein in use the two clamping arms oppose each other to clamp the support between the clamping arms with the clamping sides of each of the clamping arms abutting a substantial section of the support and the securing member is positionable to attach to the section of the ladder thereby securing the ladder to the support.

18. A clamp assembly for securing a ladder to a roof gutter wall including
two clamping arms which are connected or connectable to each other and positionable about the roof gutter wall so that the clamping arms abut a substantial section of the roof gutter wall, at least one of the clamping arms has a recess formed in a clamping side to accommodate the roof gutter wall or part thereof;
a fastening member to engage and fix one clamping arm to the other clamping arm; and
a securing member to attach to the ladder, the securing member is fixed to one of the clamping arms wherein in use the two clamping arms oppose each other to clamp the roof gutter wall between the clamping arms with the clamping sides of each of the clamping arms abutting a substantial section of the roof gutter wall and the securing member is positionable to attach to the section of the ladder thereby securing the ladder to the roof gutter wall.

19. A clamping assembly as claimed in claim 18 wherein the recess is shaped to accommodate the fold or beading of a gutter wall.

20. A clamping assembly as claimed in claim 18 wherein the recess has a substantially concave shape to accommodate a scaffolding tube or part thereof.

21. A clamping assembly as claimed in claim 18 wherein both of the clamping arms have a recess.

22. A clamping assembly as claimed in claim 21 wherein the opposing recesses are staggered.

23. A clamping assembly as claimed in claim 22 wherein the opposing recesses are aligned.

24. A clamping assembly as claimed in claim 18 wherein the recess extends across the width of the clamping arm.

25. A clamping assembly as claimed claim 18 wherein one clamping arm is pivotally attached to the other clamping arm.

26. A clamping assembly as claimed in claim 18 wherein the clamping arms are hinged about an end of each clamping arm.

27. A clamping assembly as claimed in claim 18 wherein the clamping arms are spring biased relative to each other.

28. A clamping assembly as claimed in claim 18 wherein the clamping arms are spring biased to come together for ease in positioning the clamping arms about the support or roof gutter wall.

29. A clamping assembly as claimed in claim 18 wherein there is a separate spring extending from one clamping arm to the other clamping arm.

30. A clamping assembly as claimed in claim 18 wherein there are two separate compression springs extending between the clamping arms.

31. A clamping assembly as claimed in claim 18 wherein two of the clamping assemblies are positioned either side of the ladder to secure the ladder to the roof gutter wall.
